(19) United States
(12) Patent Application Publication
(10) Pub. No.: US 2008/0237241 A1
(43) Pub. Date: Oct. 2, 2008

(54) Cookware Exhibiting an Improved Scratch Resistance

(76) Inventors: Jean-Pierre Buffard, Aix lex Bains (FR); Claudine Gardaz, Rumilly (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/594,378

(22) PCT Filed: Mar. 30, 2005
(86) PCT No.: PCT/FR2005/000775

§ 371 Date: Jan. 29, 2008

(30) Foreign Application Priority Data
Mar. 30, 2004 (FR) 0403291

(51) Int. Cl. A47J 36/02

(52) U.S. Cl. 220/573.2

(57) ABSTRACT

A culinary article formed from a metal support and a non-stick coating deposited at least on the surface of the metal support constituting the interior of the culinary article, where the non-stick coating includes at least two coats based on fluorocarbonated resin, with one of these two coats, which covers at least the worked surface of the interior of the culinary article, being a discontinuous coat forming patterns. Any cross section of the culinary article, at least at its worked surface, has regular interruptions in the plane of the discontinuous coat, and each pattern has an area of at least 1 mm², in a top view of the interior of the culinary article. The composition of the discontinuous coat formed by the patterns can include at least one fluorocarbonated resin, in addition to fillers.

This present invention concerns a culinary article that includes a non-stick coating deposited on a metal support such as aluminium or aluminium alloy.

The non-stick coatings currently used to coat culinary articles are based on a fluorocarbonated resin, such as polytetrafluoroethylene (PTFE).

Although they are known for their non-stick properties as well as for their chemical and thermal resistance, the coatings based on PTFE nevertheless have the disadvantage of being particularly prone to scratching, in particular in the area corresponding to the worked surface of the culinary article.

As a consequence, one generally observes early wear in culinary articles having this type of coating.

In order to overcome this major drawback, and to obtain non-stick coatings that have improved scratch resistance, various techniques have been developed, some of which have been the subject of patent applications such as those mentioned below. For a culinary article formed from a metal support, these techniques propose a non-stick coating deposited on this metal support, and that includes at least two coats based on fluorocarbonated resin, one of these two coats being a discontinuous coat forming patterns.

Document EP 0 285 161 described a coating that includes, starting from the metal support, a first coat deposited upon the said support and covered, where appropriate, with a second coat of pure or filled PTFE. Onto this first or second coat is then deposited a third coat known as the “reinforcing” coat.

This reinforcing coat is formed by oblong elements arranged in a network, whose composition includes PTFE and from 5 to 20% by weight, preferably from 10 to 15% by weight, of fillers, in particular of metallic or mineral powder.

The reinforcing coat is then covered with a top coat of pure or lightly-filled PTFE, which totally covers the reinforcing coat.

The surface in contact with the foodstuffs is therefore flat and so does not include deflection zones that effectively deflect the forces generated by metal objects.

Such a coating still has a certain vulnerability to scratching however. Moreover, it consumes a large quantity of the filler material used to form the reinforcing coat.

In addition, in order to overcome this vulnerability to scratching, document EP 0 580 557 proposes a non-stick coating that includes a coat of non-stick material with a thickness that is discontinuous and not constant. Such a discontinuous coat is applied onto a first coat that is continuous and of constant thickness over the whole surface of the support.

This discontinuous coat is deposited at least on the central part of the bottom of the culinary article, in a pattern which can be irregular or regular, in the form of a network of points or of graphical elements.

In the context of this last implementation technique, a major drawback arises. The top coat of the coating is formed by the discontinuous coat, which creates a type of “relief” zones.

It can be seen that this takes the form of fine cracks or crazing on the discontinuous coat which, over time, reduces the quality of the coating, which then rapidly loses its non-stick properties.

The challenge is to make a culinary article of the aforementioned type which overcomes all of the drawbacks mentioned above, this culinary article then having a non-stick coating with improved scratch resistance, and still with its non-stick properties retained over time, by avoiding the formation of fine cracks while also limiting the consumption of material.

One solution to this problem is a culinary article formed from a metal support and a non-stick coating deposited at least on the surface of the metal support constituting the interior of the culinary article, where the non-stick coating includes at least two coats based on fluorocarbonated resin, with one of these two coats, which covers at least the worked surface of the interior of the culinary article, being a discontinuous coat forming patterns. According to the invention, any cross section of the culinary article, at least at its worked surface, has regular interruptions in the plane of the discontinuous coat, and each pattern has an area of at least 1 mm², in a top view of the interior of the culinary article.

The discontinuous coat therefore has patterns arranged so that deflection zones limit the action of the forces generated by metallic or aggressive objects, and does this without creating notable “relief” zones.

In an advantageous version of the invention, the composition of the discontinuous coat formed by the patterns includes at least one fluorocarbonated resin, in addition to fillers.

The presence of fillers in the composition of the patterns reinforces the resistance of all of the discontinuous coat, and therefore strengthens the overall resistance of the non-stick coating of the culinary article.

In the particular case in which the fillers include pigments, it is possible to advantageously create a culinary article in which the discontinuous coat forms a decoration which becomes visible through the non-stick coating, in the case where the layers of non-stick coating located above the discontinuous coat are transparent.

Such a decoration, in particular when it is limited to the worked surface of the culinary article, allows the user to position the foodstuffs optimally, with a view to cooking them on the said cooking surface of the culinary article.

Moreover, in the event that scratches are nevertheless created at the worked surface of the culinary article, these would be much less visible to the naked eye because of the visual appearance conferred by the decoration.

Other advantages and particular features of the invention will emerge from the description that follows, and which is provided with reference to the appended figures, in which:

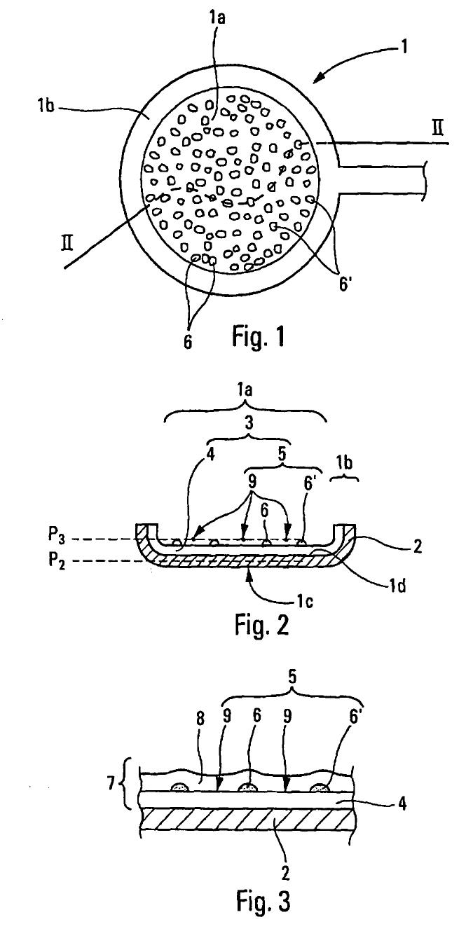

FIG. 1 shows a schematic view of the top of a culinary article according to the invention,

FIG. 2 shows a schematic view in cross section along any line II-II of the culinary article of FIG. 1,

FIG. 3 shows an enlarged schematic view in cross section of another method of implementation of a culinary article according to the invention.

The elements that are common to the various figures are identified with identical references.

FIG. 1 shows a schematic view of the top of a culinary article 1.

This culinary article 1 includes a central area 1a, which is the worked surface of the culinary article 1, and is that suitable to receive, and liable to be in contact with the foodstuffs and therefore with metal objects, and which is almost always the bottom 1c of the culinary article 1. However, this worked surface 1a could be larger than the bottom surface or indeed could be smaller.

In addition, a peripheral crown 1b represents the edge of the culinary article 1 and surrounds the said worked surface 1a.

Referring to FIG. 2, the culinary article 1 is formed from a metal support 2, and a non-stick coating 3 deposited on the metal support 2.

The metal support 2 is normally made of aluminium, aluminium alloy, stainless steel or titanium.

The non-stick coating 3 includes at least two coats based on fluorocarbonated resin, with one of these two coats covering at least the worked surface 1a of the interior of the culinary article 1, this being a discontinuous coat 5 forming patterns 6, 6′.

In FIG. 2, the non-stick coating 3 includes a first continuous coat 4 of constant thickness, covering all of the internal surface 1d of the metal support 2 and on which the discontinuous coat 5 is deposited over at least the area of the worked surface 1a, in a plane P₃ parallel to the plane of the bottom P₂, and whose patterns 6, 6′ are separated by interruptions 9 in the material constituting the discontinuous coat 5.

In another method of implementation, these two coats 4 and 5 can be inverted, with the discontinuous coat 5 then capable of being located directly on the metal support 2 and, in any event, under the first continuous coat 4 and of constant thickness.

The non-stick coating 3 according to the invention is such that any cross section on II-II, that is perpendicular to the plane P₂ formed by the bottom surface of the article 1, whether this cross section is rectilinear, meaning formed by a single straight segment and therefore incapable of being composed of a broken line, or whether it is curved, has regular interruptions 9 in the plane P₃ above and parallel to P₂ of the discontinuous coat 5, resulting firstly in a non-constant thickness of the non-stick coating 3, and secondly of a “decoration” with no line that is rectilinear, curved, parallel or cutting other lines.

Moreover, each pattern 6, 6′, from a top view of the interior of the culinary article 1, has an area of at least 1 mm². Such a minimum area requirement allows the creation of deflection zones capable of fending off the action of forces generated by metal objects. This minimum area value is also suitable for industrial implementation.

Preferably, the surface of each pattern 6, 6′ is between 1 and 10 mm². These area values in fact allow optimisation of the cohesion of the discontinuous coat 5 with the other coats forming the non-stick coating, and in particular with the first continuous coat 4 of constant thickness. The risk of formation of fine cracks is thus very clearly limited at the location of, or more generally in the vicinity of, the patterns 6, 6′.

This phenomenon of cohesion between the coats is reinforced even more by the shape given to the patterns 6, 6′, in particular when they have a simple geometrical shape such as points, circles, regular or irregular polygons, etc.

In an advantageous version of the invention, the proportion of the surface covered by the “decoration” composed of all the patterns 6, 6′ is greater than 15% of the total worked area 1a of the culinary article 1.

More preferably, this proportion of surface covered by all of the patterns 6, 6′ is between 15 and 40% of the central area 1a forming the total worked area of the culinary article 1.

The patterns 6, 6′ can be applied by any conventional means currently used for the application of non-stick coatings based on fluorocarbonated resin. By way of a non-limiting example, one can mention application by screen printing, by pad printing, by roller or indeed application by passage below a curtain screen.

However, for reasons of economy of material, the discontinuous coat 5 formed and constituting the patterns 6, 6′ is preferably applied by screen printing, in particular when the stamping operation is effected after formation of the non-stick coating 3 on the flat metal support 2.

In the case where the non-stick coating 3 is formed on the metal support 2 previously stamped according to the final shape chosen for the culinary article 1, a method of application by pad printing is preferably envisaged.

The composition of the discontinuous coat 5 constituting the patterns 6, 6′ includes at least one fluorocarbonated resin.

The fluorocarbonated resins suitable for the composition of the first coat 4 and of the discontinuous coat 5 are in particular described in document U.S. Pat. No. 5,536,583. One can mention more preferably polytetrafluoroethylene (PTFE), either pure or in combination with a copolymer of tetrafluoroethylene and perfluoropropylvinylether (PFA).

The composition of the discontinuous coat 5 forming the patterns 6, 6′ also includes pigments, aiming to confer a colour on the said patterns 6, 6′.

By way of non-limiting examples, it is possible to envisage the use of one or more pigments, chosen from soot black, the titanium oxide TiO₂, mica flakes or flakes of silica, with these flakes being covered by metal oxides.

Among the metal oxides, one can mention titanium oxide TiO₂ or iron oxide Fe₂O₃.

However there is nothing to prevent the use of thermochromic pigments, and in particular iron oxide Fe₂O₃ and/or perylene red, described in document WO 00/22395.

More preferably, the proportion by weight of the pigments is determined as a function of their ability to cover the said pigments.

This proportion by weight is currently between 0.5 and 15% of the composition of the discontinuous coat 5 forming the patterns 6, 6′. This proportion by weight can be reduced to be between 0.5 and 7.5% of the composition of the discontinuous coat 5, in particular when using pigments in the form of flakes, and/or when application of this discontinuous coat 5 is envisaged by screen printing.

FIG. 3 shows a non-stick coating 7 formed from three coats, the first coat 4 and the discontinuous coat 5 being similar to those represented in FIG. 2.

The discontinuous coat 5 is covered by at least one finish coat 8, also based on fluorocarbonated resin as described above.

One could also easily envisage the deposition of one or more additional finish coats on top of the finish coat 8 of FIG. 3.

When one is using coloured pigments in the composition of patterns 6, 6′ on the discontinuous coat 5, and the finish coat 8 is transparent, then the patterns 6, 6′ of the discontinuous coat 5 form a decoration which is visible through the finish coat 8.

Depending on the choice of colour selected for the pigments, it is possible, with advantage, to reduce the perception of any yellowing that may form on the non-stick coating 3, 7 with use.

It is also easy to envisage the creation of a culinary article that has a coating according to this present invention and that also includes, in the discontinuous coat 5 or in another coat, in the first continuous coat 4 of constant thickness, or in any other additional coat, a decoration based on fluorocarbonated resin and that includes at least one chemical substance that changes colour in a reversible manner according to temperature.

In particular, a decoration according to the above definition was described in patent application WO 00/22395 in the name of the applicant.

1-10. (canceled)

11. A culinary article formed from a metal support and a non-stick coating deposited at least on the surface of the metal support constituting the interior of the culinary article, where the non-stick coating includes at least two coats based on fluorocarbonated resin, one of these two coats covering at least the worked surface of the interior of the article, this being a discontinuous coat formed by patterns, wherein any cross section of the culinary article, at least at its worked surface, has regular interruptions in the plane of the discontinuous coat, and in that each pattern, from a top view of the interior of the culinary article, has an area of at least 1 mm².

12. A culinary article according to claim 11, wherein the area of each pattern is between 1 and 10 mm².

13. A culinary article according to claim 11, wherein the proportion of the surface covered by all of the patterns is greater than 15%, and preferably between 15 and 40%, of the total worked area of the culinary article.

14. A culinary article according to claim 11, wherein the discontinuous coat formed by the patterns is applied by screen printing or by pad printing.

15. A culinary article according to claim 11, wherein the composition of the discontinuous coat formed by the patterns includes at least one fluorocarbonated resin, and also pigments which can be thermochromic in particular.

16. A culinary article according to claim 15, wherein the pigments include at least one element chosen from soot black, titanium oxide (TiO₂), iron oxide (Fe₂O₃), perylene red, flakes of mica or flakes of silica, said flakes covered by metal oxides.

17. A culinary article according to claim 16, wherein the metal oxides are titanium oxide (TiO₂) and/or iron oxide (Fe₂O₃).

18. A culinary article according to claim 15, wherein the proportion by weight of the pigments is between 0.5 and 15%, and advantageously between 0.5 and 7.5% of the composition of the discontinuous coat formed by the patterns.

19. A culinary article according to claim 15, wherein the patterns of the discontinuous coat are visible through the non-stick coating.

20. A culinary article according to claim 11, including a pattern based on fluorocarbonated resin, including at least one chemical substance that changes color in a reversible manner as a function of temperature.
